(19) United States
(12) Patent Application Publication
(10) Pub. No.: US 2009/0254710 A1
(43) Pub. Date: Oct. 8, 2009

(54) DEVICE AND METHOD FOR CONTROLLING CACHE MEMORY

(75) Inventor: Nobuhiro NONOGAKI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/372,137

(22) Filed: Feb. 17, 2009

(30) Foreign Application Priority Data
Apr. 2, 2008 (JP) 2008-095849

(51) Int. Cl. G06F 12/12; G06F 12/08

(52) U.S. Cl. 711/133; 711/118; 711/E12.017; 711/E12.07

(57) ABSTRACT

A cache memory control device according to an embodiment of the present invention comprises: a refill counter that counts a refill request, and a cache-capacity determining unit that determines cache capacity. The cache-capacity determining unit transmits a cache-capacity-decrease command signal to the cache memory when a count value is equal to or smaller than a first threshold value or is smaller than the first threshold value, and the cache-capacity determining unit transmits a cache-capacity-increase command signal to the cache memory when the count value is equal to or larger than a second threshold value, which is larger than the first threshold value, or when the count value is larger than the second threshold value.

### CROSS-REFERENCE TO RELATED APPLICATIONS

This application is based upon and claims the benefit of priority from the prior Japanese Patent Application No. 2008-95849, filed on Apr. 2, 2008; the entire contents of which are incorporated herein by reference.

### BACKGROUND OF THE INVENTION

1. Field of the Invention

The present invention relates to a cache memory control device and a cache memory control method.

2. Description of the Related Art

To solve the bottleneck a memory access of a microprocessor, a cache memory is mounted on a chip as a conventional practice. To improve processing performance, capacity of the cache memory mounted on the chip is increasing every year. While lower power consumption of the chip has been achieved, the cache memory consumes an increasing proportion of power consumed by the microprocessor. Therefore, there are demands that power consumption of the cache memory is decreased. For example, Japanese Patent Application Laid-open No. 2005-316842, Japanese Patent Application Laid-open No. H9-50401, and Japanese Patent Application Laid-open No. 2006-309734 propose techniques of practically changing cache capacity by changing the number of ways operated in a set-associative cache memory. Cache capacity is decreased by stopping power supply to some of the ways, thereby decreasing power consumption.

For example, according to the technique proposed in Japanese Patent Application Laid-open No. 2005-316842, the number of ways is controlled based on a ratio of the number of times of hit of least recently used (LRU) entries to the number of times of hit of most recently used (MRU) entries. According to the technique proposed in Japanese Patent Application Laid-open No. H9-50401, the number of ways is controlled based on change of cache miss rate. According to the technique proposed in Japanese Patent Application Laid-open No. 2006-309734, the number of ways is controlled based on a hit rate.

Preferably, throughput improvement of a memory access via a cache memory and cache capacity are in a trade-off relationship, and are properly controlled. When capacity of transmission between the cache memory and a main memory is sufficiently secured, cache capacity can be properly controlled by monitoring a miss rate and a hit rate to an access to the cache memory. On the other hand, when plural processor cores and signal-processing exclusive hardware simultaneously access a memory via the same bus and via the same cache memory, capacity of transmission between the cache memory and the main memory often becomes a bottleneck of a system. In this case, the number of ways cannot be easily controlled by only monitoring the miss rate and the hit rate.

For example, the following two cases are assumed: a first case that the number of times of hit of MRU entry in 10,000 cycles is 1,000, the number of times of hit of LRU entry is 100, and the number of times of refill is 50; and a second case that the number of times of hit of MRU entry in 10,000 cycles is 100, the number of times of hit of LRU entry is 100, and the number of times of refill is one. According to the technique in Japanese Patent Application Laid-open No. 2005-316842, the number of ways is decreased in the first case, and the number of ways is maintained in the second case. Meanwhile, an upper limit of the number of times of refill in 10,000 cycles is assumed to be 40, based on capacity of transmission between the cache memory and the main memory. In the first case, the number of ways is decreased, although the number of times of refill exceeds the upper limit. In the second case, a large margin is left before the number of times of refill reaches the upper limit, and the number of ways is maintained although the number of ways can be decreased. This kind of behavior sometimes appears not only in the technique disclosed in Japanese Patent Application Laid-open No. 2005-316842, but also in the technique disclosed in Japanese Patent Application Laid-open No. H9-50401, and in the technique disclosed in Japanese Patent Application Laid-open No. 2006-309734. As explained above, according to the conventional techniques, the number of ways cannot be properly controlled to stabilize the number of times of refill. Japanese Patent Application Laid-open No. 2000-20396 proposes a method of determining cache capacity at the time of compilation. This method is effective to control a command memory of software. On the other hand, with this method, it is difficult to stabilize the number of times of refill of access to a data memory of signal-processing exclusive hardware or software.

### BRIEF SUMMARY OF THE INVENTION

A cache memory control device according to an embodiment of the present invention comprises: a refill counter that counts a refill request between a cache memory and a main memory; and a cache-capacity determining unit that determines the cache capacity according to a count value counted by the refill counter, wherein the cache-capacity determining unit transmits a cache-capacity-decrease command signal to the cache memory to command the cache memory to decrease the cache capacity when the count value is equal to or smaller than a first threshold value or is smaller than the first threshold value, and the cache-capacity determining unit transmits a cache-capacity-increase command signal to the cache memory to command the cache memory to increase the cache capacity when the count value is equal to or larger than a second threshold value, which is larger than the first threshold value, or when the count value is larger than the second threshold value.

A cache memory control method according to an embodiment of the present invention comprises: counting a refill request between a cache memory and a main memory; and determining the cache capacity according to a count value counted by the refill counter, wherein transmitting a cache-capacity-decrease command signal to the cache memory to command the cache memory to decrease the cache capacity when the count value is equal to or smaller than a first threshold value or is smaller than the first threshold value, and transmitting a cache-capacity-increase command signal to the cache memory to command the cache memory to increase the cache capacity when the count value is equal to or larger than a second threshold value, which is larger than the first threshold value, or when the count value is larger than the second threshold value.

An information processing device according to an embodiment of the present invention comprises: a main memory; a cache memory capable of dynamically changing cache capacity; and a cache memory control device that controls the cache capacity of the cache memory, wherein the cache memory control device includes a refill counter that counts a refill request between the cache memory and the main memory, and a cache-capacity determining unit that determines the cache capacity according to a count value counted by the refill counter, and the cache-capacity determining unit transmits a cache-capacity-decrease command signal to the cache memory to command the cache memory to decrease the cache capacity when the count value is equal to or smaller than a first threshold value or is smaller than the first threshold value, and the cache-capacity determining unit transmits a cache-capacity-increase command signal to the cache memory to command the cache memory to increase the cache capacity when the count value is equal to or larger than a second threshold value, which is larger than the first threshold value, or when the count value is larger than the second threshold value.

### BRIEF DESCRIPTION OF THE DRAWINGS

FIG. 1 is a block diagram of a schematic configuration of an information processing device having a cache memory control device according to a first embodiment of the present invention;

FIG. 2 is a state transition diagram of a cache memory for explaining cache capacity control;

FIG. 3 is a state transition diagram of a cache memory according to a second embodiment of the present invention, where the cache memory shifts to three stages of cache capacity; and

FIG. 4 is a state transition diagram of a cache memory according to a third embodiment of the present invention, where the cache memory shifts to n stages of cache capacity.

### DETAILED DESCRIPTION OF THE INVENTION

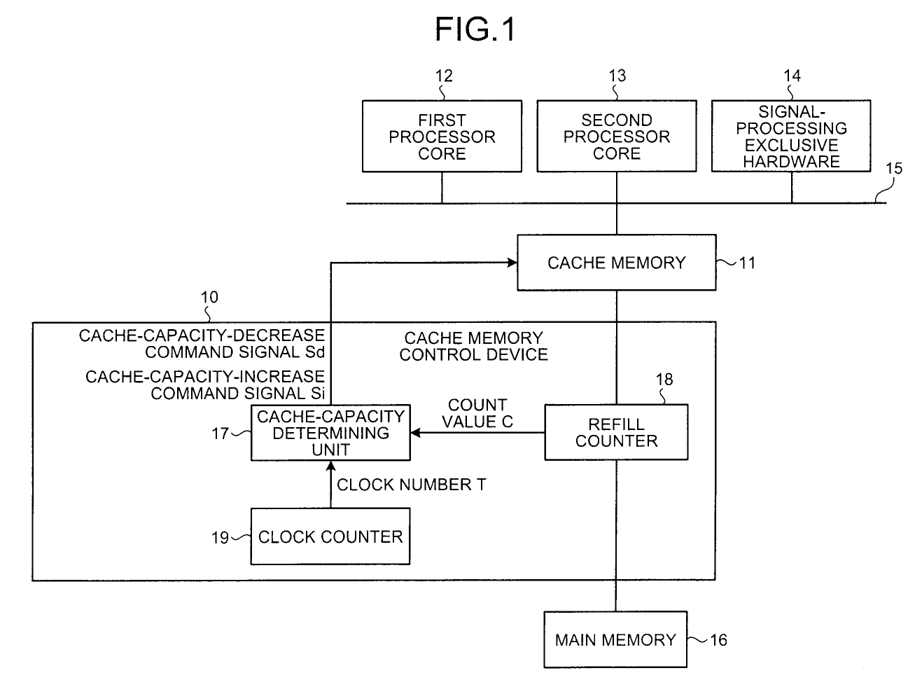

FIG. 1 is a block diagram of a schematic configuration of an information processing device having a cache memory control device 10 according to a first embodiment of the present invention. In the first embodiment, the information processing device includes a first processor core 12 and a second processor core 13 that share one cache memory 11. The first processor core 12, the second processor core 13, and a signal-processing exclusive hardware 14 transmit and receive signals using a common bus 15. A main memory 16 is an external memory provided at the outside of a processor.

The cache memory 11 is a data cache memory storing data processed by the processor. The cache memory 11 is configured to be able to dynamically change cache capacity. The cache memory 11 can take any configuration when the cache memory 11 can practically change cache capacity. Persons skilled in the art corresponding to the present invention can modify the cache memory control device 10 into a cache memory control device that control various cache memories such as a command cache memory other than a data cache memory, based on following explanations. Therefore, the following explanations should be widely understood as contents disclosed in the corresponding technique of the invention, and they do not limit the present invention.

The cache memory control device 10 is used by connecting to the cache memory 11. The cache memory control device 10 controls cache capacity of the cache memory 11. The cache memory control device 10 includes a cache-capacity determining unit 17, a refill counter 18, and a clock counter 19. The cache-capacity determining unit 17 determines the cache capacity of the cache memory 11. The refill counter 18 counts the number of times of a refill request between the cache memory 11 and the main memory 16. The clock counter 19 counts a clock number.

The refill counter 18 counts one refill request each time when the cache memory 11 transmits a request to read data from the main memory 16 or each time when the cache memory 11 transmits a request to write data into the main memory 16. Each time when a clock number counted by the clock counter 19 becomes a predetermined clock number T, the cache-capacity determining unit 17 reads a count value C of the number of times of refill counted by the refill counter 18. The clock number T expresses a predetermined unit time. The cache-capacity determining unit 17 resets the count value C of the refill counter 18 to zero each time of reading the count value C. After resetting the count value C, the refill counter 18 counts the number of times of a refill request starting from zero. The cache-capacity determining unit 17 repeats reading and reset of the count value C at every unit time.

The cache memory control device 10 can use a timer that counts time instead of using the clock counter 19. When the timer is used, the cache-capacity determining unit 17 reads the count value C each time when the timer measures a unit time. The cache-capacity determining unit 17 can be provided using a hardware configuration or using software operated in the processor.

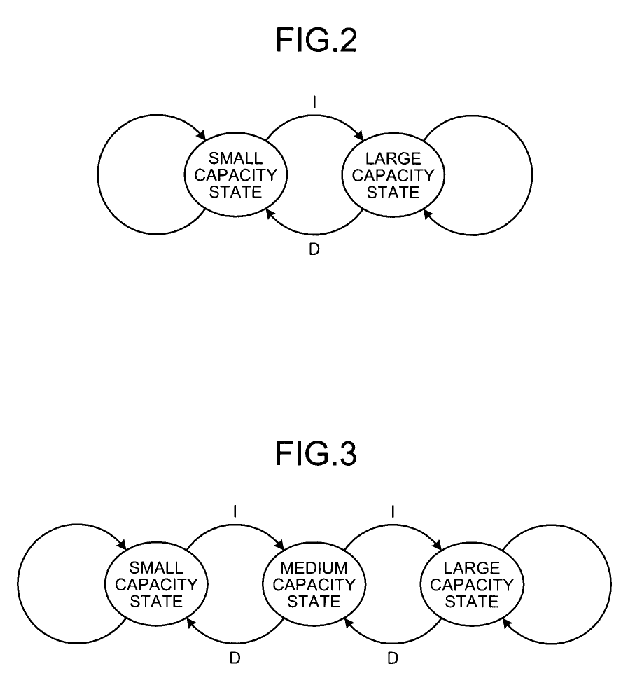

FIG. 2 is a state transition diagram of the cache memory 11 for explaining cache capacity control performed by the cache memory control device 10. The cache memory 11 can shift to mutually different two stages of cache capacity, including a small capacity state and a large capacity state. The cache-capacity determining unit 17 determines to which one of the two stages of the cache capacity the cache memory 11 is to shift. The cache-capacity determining unit 17 stores a first threshold value Th0 and a second threshold value Th1 (Th0<Th1) in a memory logic (a register or a small memory) within the cache-capacity determining unit 17. The first threshold value Th0 is a minimum permissible value of the number of times of refill, expressing an effective use of the cache capacity. The second threshold value Th1 is a maximum value of the number of times of refill to stabilize throughput.

Assume that when the cache memory 11 is in the large capacity state, the count value C is equal to or smaller than the first threshold value Th0 (C≦Th0). That the count value C is equal to or smaller than the first threshold value Th0 indicates that cache capacity is in surplus, and that the cache capacity can be decreased while maintaining a constant range of the number of times of a refill request. The cache-capacity determining unit 17 transmits a cache-capacity-decrease command signal Sd to the cache memory 11. The cache-capacity-decrease command signal Sd is used to command the cache memory 11 to decrease the cache capacity. The cache-capacity determining unit 17 transmits the cache-capacity-decrease command signal Sd to the cache memory 11 to command the cache memory 11 to shift from the large capacity state to the small capacity state. In response to the cache-capacity-decrease command signal Sd received from the cache-capacity determining unit 17, the cache memory 11 shifts from the large capacity state to the small capacity state having the cache capacity decreased by one stage, as shown by an arrowhead D in FIG. 2. The cache memory 11 can decrease power consumption while stabilizing the throughput of the system by decreasing the cache capacity of the cache memory 11 within a constant range of the number of times of refill.

When the cache memory 11 is in the small capacity state, the count value C is set larger than the second threshold value Th1 (Th1<C). That the count value C is larger than the second threshold value Th1 indicates that the cache capacity of the cache memory 11 is in shortage, and that the cache capacity needs to be increased to restrict an increase of the number of times of a refill request. The cache-capacity determining unit 17 transmits a cache-capacity-increase command signal Si to the cache memory 11. The cache-capacity-increase command signal Si is used to command the cache memory 11 to increase the cache capacity. The cache-capacity determining unit 17 transmits the cache-capacity-increase command signal Si to the cache memory 11 to command the cache memory 11 to shift from the small capacity state to the large capacity state.

In response to the cache-capacity-increase command signal Si received from the cache-capacity determining unit 17, the cache memory 11 shifts from the small capacity state to the large capacity state having the cache capacity increased, as shown by an arrowhead I in FIG. 2. The cache memory 11 can stabilize the throughput of the system by restricting the number of times of refill to within the constant range. The cache-capacity determining unit 17 resets the refill counter 18 regardless of presence of a shift of the cache capacity by the cache memory 11.

When the cache memory 11 is in the large capacity state, the cache memory 11 cannot shift to a much larger cache-capacity state. In this case, even when the cache-capacity-increase command signal Si is transmitted because the count value C is larger than the second threshold value Th1 (Th1<C), the cache memory 11 does not shift the state. When the cache memory 11 is in the large capacity state, the cache-capacity determining unit 17 can restrict the transmission of the cache-capacity-increase command signal Si.

When the cache memory 11 is in the small capacity state, the cache memory 11 cannot shift to a much smaller cache-capacity state. In this case, even when the cache-capacity-decrease command signal Sd is transmitted because the count value C is equal to or smaller than the first threshold value Th0 (C≦Th0), the cache memory 11 does not shift the state. When the cache memory 11 is in the small capacity state, the cache-capacity determining unit 17 can restrict the transmission of the cache-capacity-decrease command signal Sd.

The cache memory control device 10 controls the cache capacity based on the count value C read from the refill counter 18. The cache capacity control can stabilize the throughput of the system by maintaining within a constant range the number of times of a refill request per unit time between the cache memory 11 and the main memory 16, and the cache capacity control can decrease power consumption of the cache memory 11.

The cache memory control device 10 according to the present invention is useful when the capacity of transmission between the cache memory 11 and the main memory 16 becomes a bottleneck of the system. The control performed by the cache memory control device 10 is particularly effective when congestion of the bus 15 can be easily generated so that the plural processor cores 12 and 13 and the signal-processing exclusive hardware 14 simultaneously access the memory via the same bus 15 and the same cache memory 11. The control performed by the cache memory control device 10 is not limited to the control of the cache memory simultaneously accessed by the plural processor cores and the signal-processing exclusive hardware. The cache memory control device 10 can also control the cache memory used by a single processor core, for example.

A user suitably sets the first threshold value Th0 and the second threshold value Th1. The user can suitably set the first threshold value Th0 and the second threshold value Th1 according to a characteristic of a program and the like. Alternatively, the cache memory control device 10 can hold fixed values of the threshold values Th0 and Th1. The cache-capacity determining unit 17 can transmit the cache-capacity-decrease command signal Sd when the count value C is smaller than the first threshold value Th0 (C<Th0) instead of when the count value C is equal to or smaller than the first threshold value Th0 (C≦Th0). In addition, the cache-capacity determining unit 17 can transmit the cache-capacity-increase command signal Si when the count value C is equal to or larger than the second threshold value Th1 (Th1≦C) instead of when the count value C is larger than the second threshold value Th1 (Th1<C).

FIG. 3 is a state transition diagram of the cache memory 11 controlled by the cache memory control device 10 according to a second embodiment of the present invention. The second embodiment is similar to the first embodiment except that the cache memory 11 can shift to mutually different three stages of cache capacity. The second embodiment is explained with reference to the configuration of the cache memory control device 10 shown in FIG. 1.

The cache memory 11 can shift to the mutually different three stages of cache capacity, including a small capacity state, a medium capacity state, and a large capacity state. When the cache memory 11 is in the large capacity state and also when the count value C is equal to or smaller than the first threshold value Th0 (C≦Th0), the cache-capacity determining unit 17 transmits the cache-capacity-decrease command signal Sd to the cache memory 11 to command the cache memory 11 to shift from the large capacity state to the medium capacity state having the cache capacity decreased by one stage. The cache memory 11 shifts from the large capacity state to the medium capacity state according to the cache-capacity-decrease command signal Sd, as shown by the arrowhead D in FIG. 3.

When the cache memory 11 is in the medium capacity state and also when the count value C is equal to or smaller than the first threshold value Th0 (C≦Th0), the cache-capacity determining unit 17 transmits the cache-capacity-decrease command signal Sd to the cache memory 11 to command the cache memory 11 to shift from the medium capacity state to the small capacity state having the cache capacity decreased by one stage. The cache memory 11 shifts from the medium capacity state to the small capacity state according to the cache-capacity-decrease command signal Sd, as shown by the arrowhead D in FIG. 3. The cache memory control device 10 decreases the cache capacity of the cache memory 11 by each one stage, by transmitting the cache-capacity-decrease command signal Sd.

When the cache memory 11 is in the small capacity state and also when the count value C is larger than the second threshold value Th1 (Th1<C), the cache-capacity determining unit 17 transmits the cache-capacity-increase command signal Si to the cache memory 11 to command the cache memory 11 to shift from the small capacity state to the medium capacity state having the cache capacity increased by one stage. The cache memory 11 shifts from the small capacity state to the medium capacity state according to the cache-capacity-increase command signal Si, as shown by the arrowhead I in FIG. 3.

When the cache memory 11 is in the medium capacity state and also when the count value C is larger than the second threshold value Th1 (Th1<C), the cache-capacity determining unit 17 transmits the cache-capacity-increase command signal Si to the cache memory 11 to command the cache memory 11 to shift from the medium capacity state to the large capacity state having the cache capacity increased by one stage. The cache memory 11 shifts from the medium capacity state to the large capacity state according to the cache-capacity-increase command signal Si, as shown by the arrowhead I in FIG. 3. The cache memory control device 10 increases the cache capacity of the cache memory 11 by each one stage, by transmitting the cache-capacity-increase command signal Si. When the cache memory 11 can shift to the three stages, the cache memory control device 10 can control the cache memory 11 in appropriate cache capacity according to the state, as compared with the case that the cache memory 11 can shift to two stages.

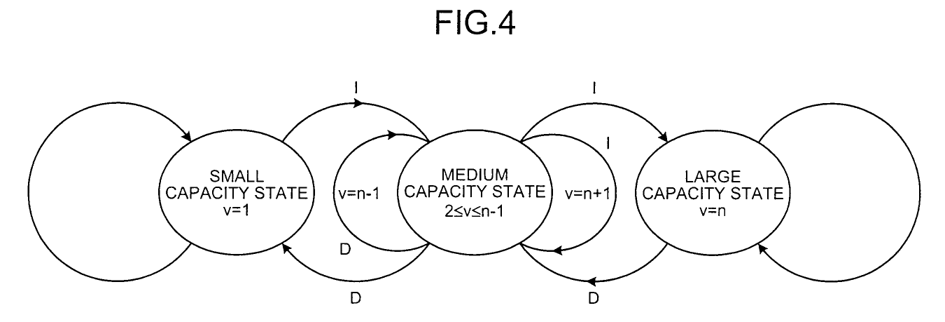

FIG. 4 is a state transition diagram of the cache memory 11 controlled by the cache memory control device 10 according to a third embodiment of the present invention. The third embodiment is similar to the first embodiment except that the cache memory 11 can shift to mutually different n stages of cache capacity, where n is an integer equal to or larger than 4. The third embodiment is explained with reference to the configuration of the cache memory control device 10 shown in FIG. 1.

The cache memory 11 can shift to the small capacity state in which the cache capacity is a minimum, the large capacity state in which the cache capacity is a maximum, and the medium capacity state in which mutually different (n−2) stages of cache capacity are present. In FIG. 4, v denotes a state variable expressing one of the cache capacity states where the cache memory 11 is in. When the state variable v is 1, the cache memory 11 is in the small capacity state, and when the state variable v is n, the cache memory 11 is in the large capacity state. Each time when the value of the state variable v increases by one, the cache capacity is in a larger state by one stage. Each time when the value of the state variable v decreases by one, the cache capacity is in a smaller state by one stage.

When the cache memory 11 is in the large capacity state (v=n) and also when the count value C is equal to or smaller than the first threshold value Th0 (C≦Th0), the cache-capacity determining unit 17 transmits the cache-capacity-decrease command signal Sd to the cache memory 11 to command the cache memory 11 to shift from the large capacity state to a state having the state variable v decreased by one. The cache memory 11 shifts from the large capacity state to the medium capacity state where v=n−1 according to the cache-capacity-decrease command signal Sd, as shown by the arrowhead D in FIG. 4.

When the cache memory 11 is in the medium capacity state where v=n−1 and also when the count value C is equal to or smaller than the first threshold value Th0 (C≦Th0), the cache-capacity determining unit 17 transmits the cache-capacity-decrease command signal Sd to the cache memory 11 to command the cache memory 11 to shift to a state having the state variable v decreased by one. The cache memory 11 shifts from the state of v=n−1 to a state of v=n−2 in the medium capacity state according to the cache-capacity-decrease command signal Sd, as shown by the arrowhead D in FIG. 4. Each time when the cache-capacity-decrease command signal Sd is input, the cache memory 11 shifts to a state having the state variable v decreased by one. Each time when the state variable v is decreased by one, the cache memory 11 can shift to the stage of n−2 in different cache capacity in the medium capacity state (2≦v≦n−1).

When the cache memory 11 is in the medium capacity state where v=2 and also when the count value C is equal to or smaller than the first threshold value Th0 (C≦Th0), the cache-capacity determining unit 17 transmits the cache-capacity-decrease command signal Sd to the cache memory 11 to command the cache memory 11 to shift to a state having the state variable v decreased by one. The cache memory 11 shifts from the medium capacity state to the small capacity state (v=1) according to the cache-capacity-decrease command signal Sd, as shown by the arrowhead D in FIG. 4.

When the cache memory 11 is in the small capacity state and also when the count value C is larger than the second threshold value Th1 (Th1≦C), the cache-capacity determining unit 17 transmits the cache-capacity-increase command signal Si to the cache memory 11 to command the cache memory 11 to shift to a state having the state variable v increased by one. The cache memory 11 shifts from the small capacity state to the medium capacity state where v=2 according to the cache-capacity-increase command signal Si, as shown by the arrowhead I in FIG. 4.

When the cache memory 11 is in the medium capacity state where v=2 and also when the count value C is larger than the second threshold value Th1 (Th1<C), the cache-capacity determining unit 17 transmits the cache-capacity-increase command signal Si to the cache memory 11 to command the cache memory 11 to shift to a state having the state variable v increased by one. The cache memory 11 shifts from the state of v=2 to a state of v=3 in the medium capacity state according to the cache-capacity-increase command signal Si, as shown by the arrowhead I in FIG. 4. Each time when the cache-capacity-increase command signal Si is input, the cache memory 11 shifts to a state having the state variable v increased by one. Each time when the state variable v is increased by one, the cache memory 11 can shift to the state of n−2 in different cache capacity in the medium capacity state (2≦v≦n−1).

When the cache memory 11 is in the medium capacity state where v=n−1 and also when the count value C is larger than the second threshold value Th1 (Th1<C), the cache-capacity determining unit 17 transmits the cache-capacity-increase command signal Si to the cache memory 11 to command the cache memory 11 to shift to a state having the state variable v increased by one. The cache memory 11 shifts from the medium capacity state to the large capacity state according to the cache-capacity-increase command signal Si, as shown by the arrowhead I in FIG. 4. The cache memory 11 can be controlled to shift to appropriate cache capacity according to a detailed state by enabling the cache memory 11 to shift to many different stages of cache capacity. When n=2, the cache memory 11 can shift to the state of two stages explained with reference to FIG. 2. When n=3, the cache memory 11 can shift to the state of three stages explained with reference to FIG. 3. The value n can be any integer equal to or larger than 2.

According to a fourth embodiment of the present invention, a difference between count values at each unit time is calculated instead of resetting the count value of the refill counter 18 at each unit time. The fourth embodiment is similar to the first embodiment except that a difference between count values is calculated. The fourth embodiment is explained with reference to the configuration of the cache memory control device 10 shown in FIG. 1.

The cache-capacity determining unit 17 reads the count value C0 of the number of times of refill counted by the refill counter 18, each unit time when a count number counted by the clock counter 19 becomes the predetermined clock number T. The cache-capacity determining unit 17 calculates a difference C (=C0−C1) between the read count value C0 and the count value C1 read immediately before the count value C0 is read. The difference C corresponds to a count value counted by the clock counter 19 during a unit time. The cache-memory control unit 10 controls cache capacity of the cache memory 11 based on the difference C obtained by calculation performed by the cache-capacity determining unit 17. The cache-capacity determining unit 17 deletes the count value C1 read immediately before after calculating the difference C, and stores the count value C0 read this time as C1. The stored count value C1 is used for the next calculation. The cache-capacity determining unit 17 repeats the calculation of the difference C and the exchange of the count value C1, at each unit time. In the fourth embodiment, the cache memory 11 can be also controlled to stabilize throughput of the system.

According to a fifth embodiment of the present invention, cache capacity can be controlled using a conversion threshold value obtained by conversion using a predetermined interval time of reading a count value, instead of reading a count value at each unit time. The fifth embodiment is similar to the fourth embodiment except that cache capacity is controlled using the conversion threshold value. The fifth embodiment is explained with reference to the configuration of the cache memory control device shown in FIG. 1.

The cache-capacity determining unit 17 reads a count value of the refill counter 18 at each predetermined time. The cache-capacity determining unit 17 reads a clock number T0 of the clock counter 19, as well as reading the count value C0 of the number of times of refill counted by the refill counter 18. The cache-capacity determining unit 17 calculates a first conversion threshold value Th0′ and a second conversion threshold value Th1′, using a clock number T1 of the clock counter 19 at the time of reading the count value C1 immediately before reading the clock number T0 and the count value C0. T0-T1 expresses the predetermined time lapsed from when the count value C1 is read until when the count value C0 is read.

Th0′=Th0×(T0−T1)

Th1′=Th1×(T0−T1)

The cache-capacity determining unit 17 compares the difference C (=C0−C1) between the count value C0 read this time and the count value C1 read immediately before, with the first conversion threshold value Th0′ and the second conversion threshold value Th1′. In the fifth embodiment, substantially a count value per unit time is compared with the original threshold values Th0 and Th1, using the conversion threshold values Th0′ and Th1′ obtained by conversion using the predetermined interval time of reading the count values.

According to the fifth embodiment, the cache memory 11 can be controlled at every optional time regardless of a unit time. The fifth embodiment is useful to achieve the cache-capacity determining unit 17 by software operated in the processor, for example. The fifth embodiment is not limited to the calculation of a difference between the count values C0 and C1, and can be applied to the resetting of the refill counter 18 at each time of reading the count value C, in a similar manner to that of the first embodiment.

According to a sixth embodiment of the present invention, the refill counter 18 counts a lapse time from a start of a refill request to a completion of the refill request, instead of the number of times of a refill request. The sixth embodiment is similar to the first embodiment except that the refill counter 18 counts the lapse time. The sixth embodiment is explained with reference to the configuration of the cache memory control device 10 shown in FIG. 1.

The refill counter 18 counts a clock number from when a refill request is started until when the refill request is completed. The refill counter 18 counts a lapse time from when the refill request is started until when the refill request is completed based on the count of the clock number. The first threshold value Th0 expresses a minimum permissible value of a lapse time of the refill request expressing an effective use of the cache capacity. The second threshold value Th1 is a maximum value of the lapse time of the refill request to stabilize throughput.

The lapse time from the start of the refill request to the completion of the refill request changes depending on the number of transmission of the refill request. Therefore, according to the sixth embodiment, cache capacity within a constant range of the number of transmission of the refill request per unit time can be controlled. Consequently, when the number of transmission of the refill request between the cache memory 11 and the main memory 16 per unit time is maintained, system throughput can be stabilized and power consumption of the cache memory 11 can be decreased. According to the sixth embodiment, the cache capacity can be properly controlled particularly when the transmission amount varies at each refill request.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cache memory control device for controlling cache memory capable of dynamically changing cache capacity comprising:
a refill counter that counts a refill request between a cache memory and a main memory; and
a cache-capacity determining unit that determines the cache capacity according to a count value counted by the refill counter, wherein
the cache-capacity determining unit transmits a cache-capacity-decrease command signal to the cache memory to command the cache memory to decrease the cache capacity when the count value is equal to or smaller than a first threshold value or is smaller than the first threshold value, and the cache-capacity determining unit transmits a cache-capacity-increase command signal to the cache memory to command the cache memory to increase the cache capacity when the count value is equal to or larger than a second threshold value, which is larger than the first threshold value, or when the count value is larger than the second threshold value.

2. The cache memory control device according to claim 1, wherein the cache memory can shift to mutually different n stages of states of the cache capacity (where n is an integer equal to or larger than 2), and
the cache-capacity determining unit transmits the cache-capacity-decrease command signal to the cache memory to command the cache memory to shift to a state having the cache capacity decreased by one stage when the count value is equal to or smaller than the first threshold value or is smaller than the first threshold value, and the cache-capacity determining unit transmits the cache-capacity-increase command signal to the cache memory to command the cache memory to shift to a state having the cache capacity increased by one stage when the count value is equal to or larger than the second threshold value or is larger than the second threshold value.

3. The cache memory control device according to claim 1, wherein the refill counter counts the number of times of the refill request.

4. The cache memory control device according to claim 1, wherein the refill counter counts a lapse time from when the refill request is started until when the refill request is completed.

5. The cache memory control device according to claim 1, wherein the cache-capacity determining unit transmits the cache-capacity-decrease command signal when the count value per unit time is equal to or smaller than the first threshold value or is smaller than the first threshold value, and the cache-capacity determining unit transmits the cache-capacity-increase command signal when the count value per unit time is equal to or larger than the second threshold value or is larger than the second threshold value.

6. The cache memory control device according to claim 2, wherein the refill counter counts the number of times of the refill request.

7. The cache memory control device according to claim 2, wherein the refill counter counts a lapse time from when the refill request is started until when the refill request is completed.

8. The cache memory control device according to claim 2, wherein the cache-capacity determining unit transmits the cache-capacity-decrease command signal when the count value per unit time is equal to or smaller than the first threshold value or is smaller than the first threshold value, and the cache-capacity determining unit transmits the cache-capacity-increase command signal when the count value per unit time is equal to or larger than the second threshold value or is larger than the second threshold value.

9. The cache memory control device according to claim 3, wherein the cache-capacity determining unit transmits the cache-capacity-decrease command signal when the count value per unit time is equal to or smaller than the first threshold value or is smaller than the first threshold value, and the cache-capacity determining unit transmits the cache-capacity-increase command signal when the count value per unit time is equal to or larger than the second threshold value or is larger than the second threshold value.

10. The cache memory control device according to claim 4, wherein the cache-capacity determining unit transmits the cache-capacity-decrease command signal when the count value per unit time is equal to or smaller than the first threshold value or is smaller than the first threshold value, and the cache-capacity determining unit transmits the cache-capacity-increase command signal when the count value per unit time is equal to or larger than the second threshold value or is larger than the second threshold value.

11. The cache memory control device according to claim 5, wherein the cache-capacity determining unit reads the count value of the refill counter at each unit time.

12. The cache memory control device according to claim 5, wherein the cache-capacity determining unit reads the count value of the refill counter at each predetermined time, and compares a conversion value obtained by conversion using the predetermined time with the count value counted by the refill counter during the predetermined time.

13. The cache memory control device according to claim 5, wherein the cache-capacity determining unit resets the count value of the refill counter each time when the count value is read.

14. The cache memory control device according to claim 5, wherein the cache-capacity determining unit calculates a difference between a read count value and a count value read immediately before the count value is read.

15. A cache memory control method for controlling cache memory capable of dynamically changing cache capacity comprising:
counting a refill request between a cache memory and a main memory; and
determining the cache capacity according to a count value of the refill request, wherein
transmitting a cache-capacity-decrease command signal to the cache memory to command the cache memory to decrease the cache capacity when the count value is equal to or smaller than a first threshold value or is smaller than the first threshold value, and transmitting a cache-capacity-increase command signal to the cache memory to command the cache memory to increase the cache capacity when the count value is equal to or larger than a second threshold value, which is larger than the first threshold value, or when the count value is larger than the second threshold value.

16. The cache memory control method according to claim 15, wherein the cache memory can shift to mutually different n stages of states of the cache capacity (where n is an integer equal to or larger than 2), and
transmitting the cache-capacity-decrease command signal to the cache memory to command the cache memory to shift to a state having the cache capacity decreased by one stage when the count value is equal to or smaller than the first threshold value or is smaller than the first threshold value, and transmitting the cache-capacity-increase command signal to the cache memory to command the cache memory to shift to a state having the cache capacity increased by one stage when the count value is equal to or larger than the second threshold value or is larger than the second threshold value.

17. The cache memory control method according to claim 15, wherein counting the number of times of the refill request.

18. The cache memory control method according to claim 15, wherein counting a lapse time from when the refill request is started until when the refill request is completed.

19. The cache memory control method according to claim 15, wherein transmitting the cache-capacity-decrease command signal when the count value per unit time is equal to or smaller than the first threshold value or is smaller than the first threshold value, and transmitting the cache-capacity-increase command signal when the count value per unit time is equal to or larger than the second threshold value or is larger than the second threshold value.

20. An information processing device comprising:
a main memory;
a cache memory capable of dynamically changing cache capacity; and
a cache memory control device that controls the cache capacity of the cache memory, wherein
the cache memory control device includes
a refill counter that counts a refill request between the cache memory and the main memory, and
a cache-capacity determining unit that determines the cache capacity according to a count value counted by the refill counter, and
the cache-capacity determining unit transmits a cache-capacity-decrease command signal to the cache memory to command the cache memory to decrease the cache capacity when the count value is equal to or smaller than a first threshold value or is smaller than the first threshold value, and the cache-capacity determining unit transmits a cache-capacity-increase command signal to the cache memory to command the cache memory to increase the cache capacity when the count value is equal to or larger than a second threshold value, which is larger than the first threshold value, or when the count value is larger than the second threshold value.
